(19) United States
(12) Patent Application Publication
(10) Pub. No.: US 2016/0218392 A1
(43) Pub. Date: Jul. 28, 2016

(54) ORGANIC ELECTROLYTIC SOLUTION AND LITHIUM BATTERY EMPLOYING THE ORGANIC ELECTROLYTIC SOLUTION

(71) Applicant: Samsung SDI Co., Ltd., Yongin-si (KR)

(72) Inventors: Seungtae Lee, Yongin-si (KR); Soojin Kim, Yongin-si (KR); Minju Lee, Yongin-si (KR); Woocheol Shin, Yongin-si (KR)

(21) Appl. No.: 14/996,123

(22) Filed: Jan. 14, 2016

(30) Foreign Application Priority Data
Jan. 23, 2015 (KR) 10-2015-0011289

(51) Int. Cl. H01M 10/0567; H01M 10/0569; H01M 10/0568; H01M 10/0525

(52) U.S. Cl. CPC H01M 10/0567; H01M 10/0525; H01M 10/0569; H01M 10/0568; H01M 2300/0028; H01M 2300/0037; H01M 2220/20; H01M 2220/30

(57) ABSTRACT

The present disclosure provides an organic electrolytic solution including an organic solvent, a lithium salt, one or more ester sulfate compounds, and one or more phosphoric acid-based ester compounds, and a lithium battery including the organic electrolytic. The lifetime characteristics and high temperature storage characteristics of lithium batteries including this organic electrolytic solution composition may be improved

### CROSS-REFERENCE TO RELATED APPLICATION

This application claims priority to and the benefit of Korean Patent Application No. 10-2015-0011289, filed on Jan. 23, 2015, in the Korean Intellectual Property Office, the entire content of which is incorporated herein by reference.

### BACKGROUND

1. Field

One or more aspects of example embodiments relate to an organic electrolytic solution and a lithium battery employing the organic electrolytic solution.

2. Description of the Related Art

Lithium batteries are used as power supplies to drive portable electric devices such as video cameras, cellular phones, and laptop computers. Rechargeable lithium secondary batteries are capable of performing high speed charging and have three (3) times or higher energy densities per unit weight, compared to existing lead storage batteries, nickel-cadmium batteries, nickel-metal hydride batteries, nickel-zinc batteries, etc.

Lithium batteries operate at a high driving voltage, and thus aqueous-based electrolyte solutions that are highly reactive with lithium may not be used in the lithium batteries. A lithium battery typically uses an organic electrolyte solution. The organic electrolyte solution is prepared by dissolving a lithium salt in an organic solvent. The organic solvent is stable at a high voltage, and a suitable organic solvent may have high ion conductivity, high permittivity, and low viscosity.

When a lithium battery includes an organic electrolyte solution including a lithium salt, an irreversible reaction that consumes excessive charges may proceed due to side reactions between the anode and/or cathode and the electrolyte solution. As a result of the side reaction, a passivation layer such as a solid electrolyte interphase (hereinafter, referred to as “SEI”) may be formed on the surface of the anode.

The lithium salts may react with the organic solvents in the electrolytic solution during charging and discharging to consume the organic solvents, generate gases, and form SEIs having high resistance values such that, as a result, the lifetime characteristics of the lithium batteries are deteriorated.

One or more suitable additives may be used to prevent or reduce the lifetime characteristics of such lithium batteries from being deteriorated. For example, ethylene sulfate may be used. These additives may cause an improvement in lifetime characteristics (e.g., capacity retention over cycle life) of the lithium batteries at room temperature. However, when the lithium batteries are exposed to high temperatures, these additives may cause an increase in the internal resistance of the lithium batteries, thereby lowering the voltages of the lithium batteries during discharging.

Therefore, organic electrolytic solutions that have good lifetime characteristics at room temperature and are resistant to voltage drops during discharging even after exposure to high temperatures are required.

The above information disclosed in this Background section is included only to enhance understanding of the background of the present disclosure, and may therefore contain information that does not form the prior art that is already known in this country to a person of ordinary skill in the art.

### SUMMARY

One or more aspects of example embodiments of the present disclosure are directed toward a novel organic electrolytic solution.

One or more aspects of example embodiments of the present disclosure provide a lithium battery including the organic electrolytic solution.

Additional aspects will be set forth in part in the description which follows and, in part, will be apparent from the description, or may be learned by practice of the presented embodiments.

One or more example embodiments of the present disclosure provide an organic electrolytic solution including an organic solvent, a lithium salt, ester sulfate compounds represented by the following Formula 1, and one or more selected from the phosphoric acid-based ester compounds represented by one or more of the following Formulas 2 and 3:

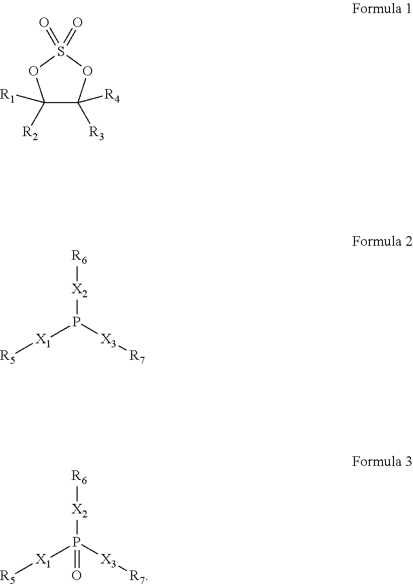

In Formulas 2 and 3, R₁, R₂, R₃, and R₄ may each independently be selected from hydrogen and an unsubstituted or halogen-substituted C₁-C₅ alkyl group, and at least one selected from R₁, R₂, R₃, and R₄ is an alkyl group; X₁, X₂, and X₃ may each independently be selected from O, S, and NR₈; R₅, R₆, R₇, and R₈ may each independently be selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ may each independently be selected from an unsubstituted or halogen-substituted C₁-C₅ alkyl group.

One or more example embodiments of the present disclosure provide a lithium battery including a cathode, an anode, and the above-described organic electrolytic solution.

### BRIEF DESCRIPTION OF THE DRAWINGS

These and/or other aspects will become apparent and more readily appreciated from the following description of the example embodiments, taken in conjunction with the accompanying drawings in which:

FIG. 1 is a graph showing lifetime characteristics (e.g., capacity retention over cycle life) at room temperature (25° C.) of lithium batteries manufactured in Comparative Examples 4 to 6;

FIG. 2A is a graph showing cyclic voltammograms of an organic electrolytic solution prepared in Comparative Example 1;

FIG. 2B is a graph showing cyclic voltammograms of an organic electrolytic solution prepared in Comparative Example 2;

FIG. 2C is a graph showing cyclic voltammograms of an organic electrolytic solution prepared in Comparative Example 3;

FIG. 2D is a graph comparing first cycle cyclic voltammograms of organic electrolytic solutions prepared in Comparative Examples 1 to 3;

FIG. 3 is a graph showing lifetime characteristics (e.g., capacity retention over cycle life) at room temperature (25° C.) of lithium batteries manufactured in Examples 7 to 10 and Comparative Examples 4 to 5;

FIG. 4 is a graph showing storage characteristics (e.g., voltage retention) after resting at a high temperature (60° C.) of lithium batteries manufactured in Examples 6 to 10 and Comparative Example 5; and

FIG. 5 is a schematic diagram showing a lithium battery according to one or more example embodiments.

### DETAILED DESCRIPTION

Reference will now be made in more detail to example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are merely described below, by referring to the drawings, to explain aspects of the present description. As used herein, the term “and/or” includes any and all combinations of one or more of the associated listed items. Expressions such as “at least one of”, “one of”, “one selected from”, and “at least one selected from”, when preceding a list of elements, modify the entire list of elements and do not modify the individual elements of the list.

Hereinafter, an organic electrolytic solution according to one or more example embodiments and a lithium battery employing the organic electrolytic solution will be described in more detail.

According to one or more example embodiments, an organic electrolytic solution includes an organic solvent, a lithium salt, ester sulfate compounds represented by the following Formula 1, and one or more phosphoric acid-based ester compounds represented by one or more of the following Formulas 2 and 3:

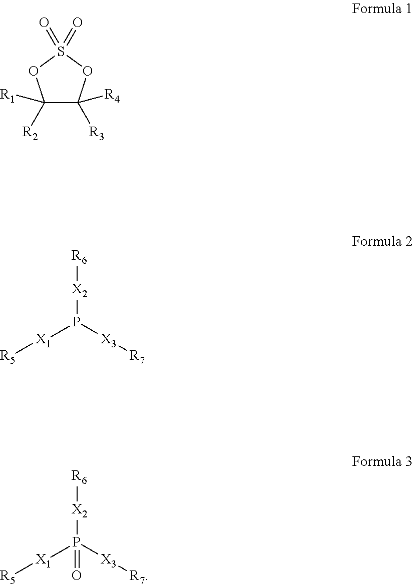

In Formulae 1 to 3, R₁, R₂, R₃, and R₄ may each independently be selected from hydrogen and an unsubstituted or halogen-substituted C₁-C₅ alkyl group, and at least one selected from R₁, R₂, R₃, and R₄ is an alkyl group; X₁, X₂, and X₃ may each independently be selected from O, S, and NR₈; R₅, R₆, R₇, and R₈ may each independently be selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ may each independently be selected from an unsubstituted or halogen-substituted C₁-C₅ alkyl group.

The organic electrolytic solution may suppress or reduce the formation of a high resistance solid electrolyte interphase film, and may be stable at high temperatures, thus preventing or reducing deterioration of battery performance metrics such as lifetime characteristics, high temperature storage characteristics, and other characteristics.

Hereinafter, the reasons why the organic electrolytic solution improves the performance of the lithium battery will be described in more detail. However, the following description is only provided to enhance understanding of the organic electrolytic solution, and the range of technical characteristics of the organic electrolytic solution is not limited to the following description.

In some embodiments, the ester sulfate compounds decompose during the initial charging and discharging process, thereby forming a strong solid electrolyte interphase film having a low resistance and improved durability on the anode surface and preventing or reducing the lifetime characteristics of a lithium battery from deteriorating. In some embodiments, the phosphoric acid-based ester compounds coordinate to (e.g., couple with) the lithium salt and/or stabilize the lithium salt, such that side reactions caused by decomposition of the lithium salt at high temperatures may be suppressed. Therefore, an organic electrolytic solution may exhibit high temperature storage characteristics with a suppressed voltage drop, (e.g., may suppress or reduce increases in internal resistance, since the phosphoric acid-based ester compounds suppress or reduce side reactions when the organic electrolytic solution is stored at high temperatures).

Therefore, the organic electrolytic solution including the ester sulfate compounds and the phosphoric acid-based ester compounds may suppress side reactions of the organic electrolytic solution at high temperatures and may form a durable solid electrolyte film having a low resistance value. As a result, a lithium battery including the organic electrolytic solution of embodiments of the present disclosure may have improved high temperature stability and lifetime characteristics.

In some embodiments, since the phosphoric acid-based ester compounds do not easily decompose during charging and discharging, and coordinate to (e.g., couple with) the lithium salt to stabilize the lithium salt, lithium salts that are unstable at high temperatures can be prevented from being pyrolyzed (e.g., the degree of pyrolysis may be reduced). In contrast, since phosphate-based metal complex compounds such as lithium difluoro bis-(oxalate)phosphate (LDFOP), etc. decompose during charging and discharging and do not coordinate to the lithium salt, the lithium salt is not protected from being pyrolyzed at high temperatures. Therefore, the phosphoric acid-based ester compounds may provide improved high temperature stability when compared to the phosphate-based metal complex compounds.

In some embodiments, the ester sulfate compounds in the organic electrolytic solution may be further represented by one or more of the following Formulas 4 to 6.

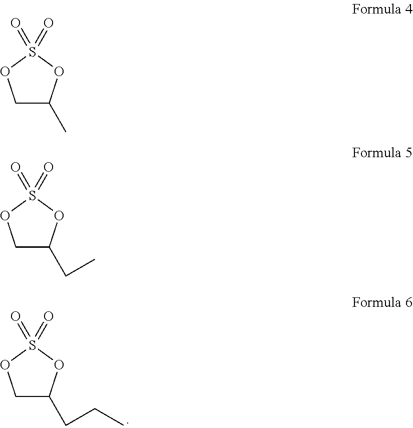

in some embodiments, the phosphoric acid-based ester compounds represented by Formula 2 in the organic electrolytic solution may be further represented by one or more of the following Formulas 7 and 8:

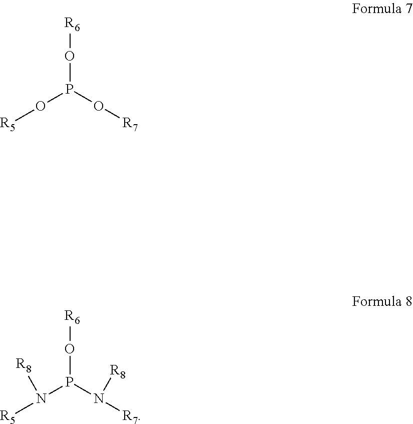

In Formulae 7 and 8, R₅, R₆, R₇, and R₈ may each independently be selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ may each independently be selected from an unsubstituted or halogen-substituted C₁-C₅ alkyl group.

In some embodiments, the phosphoric acid-based ester compounds represented by Formula 3 in the organic electrolytic solution may be further represented by the following Formula 9:

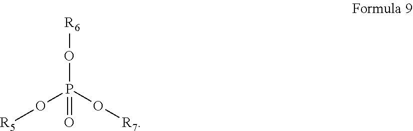

In Formula 9, R₅, R₆, R₇, and R₈ may each independently be selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ may each independently be selected from an unsubstituted or halogen-substituted C₁-C₅ alkyl group.

In some embodiments, the phosphoric acid-based ester compounds in the organic electrolytic solution may be represented by one or more of the following Formulas 10 to 17:

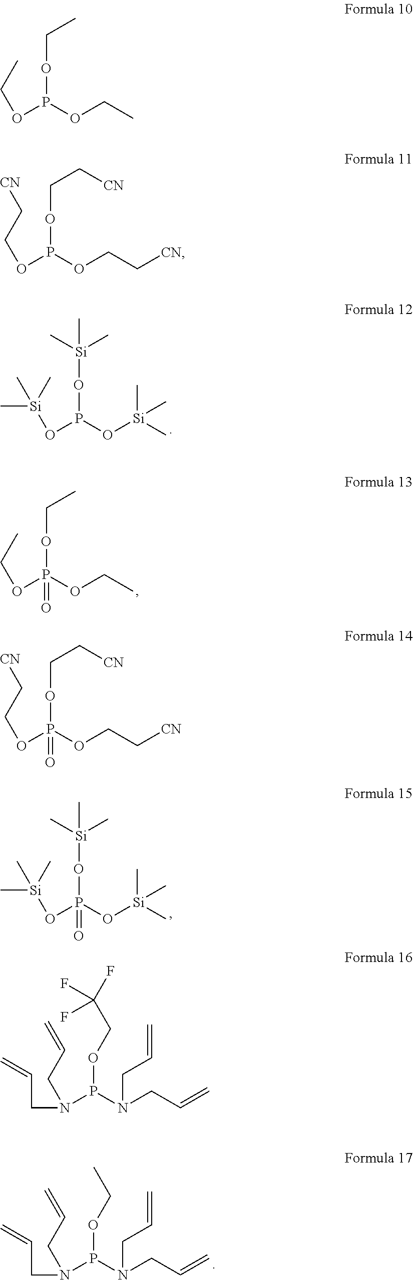

The ester sulfate compounds may be included in the organic electrolytic solution in an amount of about 0.1 wt % to about 10 wt % based on the total weight of the organic electrolytic solution. However, amounts of the ester sulfate compounds included in the organic electrolytic solution are not limited to this range, and the ester sulfate compounds may be included in the organic electrolytic solution in appropriate or suitable amounts as needed. In some embodiments, ester sulfate compounds may be included in the organic electrolytic solution in an amount of about 0.1 wt % to about 7 wt % based on the total weight of the organic electrolytic solution. In some embodiments, ester sulfate compounds may be included in the organic electrolytic solution in an amount of about 0.1 wt % to about 5 wt % based on the total weight of the organic electrolytic solution. In some embodiments, ester sulfate compounds may be included in the organic electrolytic solution in an amount of about 0.1 wt % to about 3 wt % based on the total weight of the organic electrolytic solution. In some embodiments, ester sulfate compounds may be included in the organic electrolytic solution in an amount of about 0.1 wt % to about 2 wt % based on the total weight of the organic electrolytic solution. Improved battery characteristics may be obtained when the amount of ester sulfate compounds is within the above ranges.

The phosphoric acid-based ester compounds may be included in the organic electrolytic solution in an amount of about 0.1 wt % to about 10 wt % based on the total weight of the organic electrolytic solution. However, amounts of the phosphoric acid-based ester compounds included in the organic electrolytic solution are not necessarily limited to this range, and the phosphoric acid-based ester compounds may be included in the organic electrolytic solution in appropriate or suitable amounts as needed. In some embodiments, phosphoric acid-based ester compounds may be included in the organic electrolytic solution in an amount of about 0.1 wt % to about 7 wt % based on the total weight of the organic electrolytic solution. In some embodiments, phosphoric acid-based ester compounds may be included in the organic electrolytic solution in an amount of about 0.1 wt % to about 5 wt % based on the total weight of the organic electrolytic solution. In some embodiments, phosphoric acid-based ester compounds may be included in the organic electrolytic solution in an amount of about 0.1 wt % to about 3 wt % based on the total weight of the organic electrolytic solution. In some embodiments, phosphoric acid-based ester compounds may be included in the organic electrolytic solution in an amount of about 0.1 wt % to about 2 wt % based on the total weight of the organic electrolytic solution. Improved battery characteristics may be obtained when the amount of phosphoric acid-based ester compounds is within the above ranges.

The ester sulfate compounds and the phosphoric acid-based ester compounds may be included in the organic electrolytic solution in a composition ratio of about 10 parts by weight to about 500 parts by weight of the phosphoric acid-based ester compounds with respect to 100 parts by weight of the ester sulfate compounds. However, the composition ratios of the ester sulfate compounds and the phosphoric acid-based ester compounds included in the organic electrolytic solution are not necessarily limited to the above composition ratios, and the composition ratios may be appropriately or suitably selected within the range as needed. In some embodiments, the ester sulfate compounds and the phosphoric acid-based ester compounds may be included in the organic electrolytic solution in a composition ratio of about 10 parts by weight to about 400 parts by weight of the phosphoric acid-based ester compounds with respect to 100 parts by weight of the ester sulfate compounds. In some embodiments, the ester sulfate compounds and the phosphoric acid-based ester compounds may be included in the organic electrolytic solution in a composition ratio ranges of about 10 parts by weight to about 300 parts by weight of the phosphoric acid-based ester compounds with respect to 100 parts by weight of the ester sulfate compounds. In some embodiments, the ester sulfate compounds and the phosphoric acid-based ester compounds may be included in the organic electrolytic solution in a composition ratio of about 10 parts by weight to about 200 parts by weight of the phosphoric acid-based ester compounds with respect to 100 parts by weight of the ester sulfate compounds.

The organic solvent may include low boiling point solvents in the organic electrolytic solution. As used herein, “low boiling point solvents” may refer to solvents having a boiling point of about 200° C. or lower at 1 atmosphere.

Non-limiting examples of the organic solvent may include one or more selected from dialkyl carbonates, cyclic carbonates, linear and cyclic esters, linear and cyclic amides, aliphatic nitriles, linear and cyclic ethers, and/or derivatives thereof.

Non-limiting examples of the organic solvent may include one or more selected from dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), butylene carbonate, ethyl propionate, ethyl butyrate, acetonitrile, succinonitrile (SN), dimethyl sulfoxide, dimethyl formamide, dimethyl acetamide, γ-valerolactone, γ-butyrolactone, and tetrahydrofuran. However, the organic solvent is not necessarily limited to these examples, and the examples of the organic solvent may include all suitable low boiling point solvents that are available in the relevant art.

The lithium salt may be included in the organic electrolytic solution at a concentration of about 0.01 M to about 2.0 M. However, the concentration of lithium salt included in the organic electrolytic solution is not necessarily limited to this range, and an appropriate or suitable concentration of the lithium salt included in the organic electrolytic solution may be used as needed. Improved battery characteristics may be obtained when the lithium salt is included within the above concentration range.

Non-limiting examples of the lithium salt used in the organic electrolytic solution may include all suitable lithium salt materials that are available in the relevant art, such as LiPF₆, LiBF₄, LiSbF₆, LiAsF₆, LiCIO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each an integer selected from 1 to 20), LiCl, LiI, and/or mixtures thereof. In some embodiments, the lithium salt in the organic electrolytic solution may be LiPF₆.

The organic electrolytic solution may be in a liquid state or a gel state. The organic electrolytic solution may be prepared by adding the above-described ester sulfate compounds and phosphoric acid-based ester compounds to organic solvents.

One or more example embodiments of the present disclosure provides a lithium battery including a cathode, an anode, and the above-described organic electrolytic solution. The forms or types of lithium battery are not particularly limited, and may include lithium primary batteries as well as lithium secondary batteries such as lithium ion batteries, lithium ion polymer batteries, lithium sulfur batteries, etc.

In some embodiments, the cathode in the lithium battery may include nickel. For example, a positive active material of the cathode may be a lithium transition metal oxide including nickel. For example, the positive active material of the cathode may be a nickel rich lithium transition metal oxide, in which nickel is the highest concentration transition metal contained in the cathode.

In some embodiments, the anode in the lithium battery may include graphite as a negative active material, and the lithium battery may have a high voltage of about 4.8 V or higher.

In some embodiments, the lithium battery may be manufactured by the following method:

First, a cathode is prepared.

For example, a positive active material composition may be prepared by mixing a positive active material, a conducting agent, a binder, and a solvent. The positive active material composition may be directly coated and dried on a metal current collector to manufacture a cathode plate. Alternatively, the positive active material composition may be cast on a separate support, and a film delaminated from the support may be laminated on a metal current collector to manufacture a cathode plate. The cathode is not limited to the above-mentioned forms, but may include other forms.

The positive active material may be a lithium-containing metal oxide, and may be selected from any suitable material available in the relevant art, without limitation. Examples of the positive active material may include one or more composite oxides formed by combining lithium with metals selected from cobalt, manganese, nickel, and/or mixtures thereof, and non-limiting examples of the positive active material may include compounds represented by any formula selected from: LiₐAl_{1-b}B′_{b}D₂ (wherein 0.90≦a≦1.8 and 0≦b≦0.5); LiₐE_{1-b}B′_{b}O_{2-c}D_{c} (wherein 0.90≦a≦1.8, 0≦b≦0.5, and 0≦c≦0.05); LiE_{2-b}B′_{b}O_{4-c}D_{c} (wherein 0≦b≦0.5 and 0≦c≦0.05); LiₐNi_{1-b-c}Co_{b}B′_{c}D_{α} (wherein 0.90≦a≦1.8, 0≦b≦0.5, 0≦c≦0.05, and 0≦α≦2); LiₐNi_{1-b-c}Co_{b}B′_{c}O_{2-α}F′₆₀ (wherein 0.90≦a≦1.8, 0≦b≦0.5, 0≦c≦0.05, and 0<α<2); LiₐNi_{1-b-c}Co_{b}B′_{c}O_{2-α}F′₂ (wherein 0.90≦a≦1.8, 0≦b≦0.5, 0≦c≦0.05, and 0<α<2); LiₐNi_{1-b-c}Mn_{b}B′_{c}D_{α} (wherein 0.90≦a≦1.8, 0≦b≦0.5, 0≦c≦0.05, and 0<α≦2); LiₐNi_{1-b-c}Mn_{b}B′_{c}O_{2-α}F′_{α} (wherein 0.90≦a≦1.8, 0≦b≦0.5, 0≦c≦0.05, and 0<α<2); LiₐNi_{1-b-c}Mn_{b}B′_{c}O_{2-α}F′₂ (wherein 0.90≦a≦1.8, 0≦b≦0.5, 0≦c≦0.05, and 0<α<2); LiₐNi_{b}E_{c}G_{d}O₂ (wherein 0.90≦a≦1.8, 0≦b≦0.9, 0≦c≦0.5, and 0.001≦d≦0.1); LiₐNi_{b}Co_{c}Mn_{d}GₑO₂ (wherein 0.90≦a≦1.8, 0≦b≦0.9, 0≦c≦0.5, 0≦d≦0.5, and 0.001≦e≦0.1); LiₐNiG_{b}O₂ (wherein 0.90≦a≦1.8 and 0.001≦b≦0.1); LiₐCoG_{b}O₂ (wherein 0.90≦a≦1.8 and 0.001≦b≦0.1); LiₐMnG_{b}O₂ (wherein 0.90≦a≦1.8 and 0.001≦b≦0.1); LiₐMN₂G_{b}O₄ (wherein 0.90≦a≦1.8 and 0.001≦b≦0.1); QO₂; QS₂; :oQS₂; V₂O₅; LiV₂O₅; LiI′O₂; LiNiVO₄; Li_{(3-f)}J₂(PO₄)₃ (wherein 0≦f≦2); Li_{(3-f)}Fe₂(PO₄)₃ (wherein 0≦f≦2); and LiFePO₄.

In the above formulas, A may be selected from nickel (Ni), cobalt (Co), manganese (Mn), and mixtures thereof; B′ may be selected from aluminum (Al), Ni, Co, Mn, chromium (Cr), iron (Fe), magnesium (Mg), strontium (Sr), vanadium (V), rare earth elements, and mixtures thereof; D may be selected from oxygen (O), fluorine (F), sulfur (S), phosphorus (P), and mixtures thereof; E may be selected from Co, Mn, and a mixture thereof; F′ may be selected from F, S, P, and mixtures thereof; G may be selected from Al, Cr, Mn, Fe, Mg, lanthanum (La), cerium (Ce), strontium (Sr), V, and mixtures thereof; Q may be selected from titanium (Ti), molybdenum (Mo), Mn, and mixtures thereof; I′ may be selected from Cr, V, Fe, scandium (Sc), yttrium (Y), and mixtures thereof; and J may be selected from V, Cr, Mn, Co, Ni, copper (Cu), and mixtures thereof.

Non-limiting examples of the positive active material may include LiCoO₂, LiMnₓO₂ₓ (x=1, 2), LiNi₁₋ₓMnₓO₂ₓ (0<x<1), LiNi_{1-x-y}CoₓMn_{y}O₂ (0≦x≦0.5, 0≦y≦0.5, 1−x−y>0.5), LiFePO₄, etc.

Examples of the positive active material may additionally include compounds having coating layers formed on surfaces thereof, and mixtures of the compounds and the compounds having the coating layers. The coating layers may include coating element compounds such as oxides of coating elements, hydroxides, oxyhydroxides of the coating elements, oxycarbonates of the coating elements, and hydroxycarbonates of the coating elements. The compounds that form these coating layers may be amorphous or crystalline. Non-limiting examples of the coating elements included in the coating layers may include Mg, Al, Co, potassium (K), sodium (Na), calcium (Ca), silicon (Si), Ti, V, tin (Sn), germanium (Ge), gallium (Ga), boron (B), arsenic (As), zirconium (Zr), and mixtures thereof. Any suitable coating method may be used in the coating layer forming process, including spray coating, dipping, and others that do not have a negative effect on the physical properties of the positive active material. Detailed descriptions of the coating methods will not be provided since they are well understood by one of ordinary skill in the relevant art.

Non-limiting examples of the conducting agent may include carbon black, graphite particles, etc. However, the conducting agent is not limited to the above examples, and examples of the conducting agent may include all suitable materials available in the relevant art.

Non-limiting examples of the binder may include vinylidene fluoride-hexafluoropropylene copolymers, polyvinylidene fluoride (PVDF), polyacrylonitrile, polymethyl methacrylate, polytetrafluoroethylene (PTFE), mixtures thereof, styrene butadiene rubber-based polymers, etc. However, the binder is not limited to the above examples, and examples of the binder may include all suitable materials that are available in the relevant art.

Non-limiting examples of the solvent may include N-methylpyrrolidone, acetone, water, etc. However, the solvent is not limited to the above examples, and examples of the solvent may include all suitable materials that are available in the relevant art.

The positive active material, conducting agent, binder, and solvent may be included in amounts that are suitably used in lithium batteries in the related art. One or more selected from the conducting agent, binder, and solvent may be omitted depending on the intended uses and compositions of the lithium battery.

Next, an anode is prepared.

For example, a negative active material composition may be prepared by mixing a negative active material, a conducting agent, a binder, and a solvent. The negative active material composition may be directly coated and dried on a metal current collector to manufacture an anode plate. Alternatively, the negative active material composition may be cast on a separate support, and a film delaminated from the support may be laminated on a metal current collector to manufacture an anode plate.

The negative active material may be selected from any suitable material that is available in the relevant art. Examples of the negative active material may include one or more selected from lithium metals, metals that are alloyable with lithium, transition metal oxides, non-transition metal oxides, and carbonaceous materials.

Non-limiting examples of metals that are alloyable with lithium may include Si, Sn, Al, Ge, lead (Pb), bismuth (Bi), antimony (Sb), Si—Y alloys (wherein Y is selected from the alkali metals, alkali earth metals, Group 13 elements, Group 14 elements excluding Si, transition metals, rare earth elements, and combined elements thereof), Sn—Y alloys (wherein Y is selected from the alkali metals, alkali earth metals, Group 13 elements, Group 14 elements excluding Sn, transition metals, rare earth elements, and combined elements thereof), etc. Non-limiting examples of the element Y may include Mg, Ca, Sr, barium (Ba), radium (Ra), Sc, Y, Ti, Zr, hafnium (Hf), rutherfordium (Rf), V, niobium (Nb), tantalum (Ta), dubnium (Db), Cr, Mo, tungsten

(W), seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), Cu, silver (Ag), gold (Au), zinc (Zn), cadmium (Cd), B, AI, Ga, Sn, indium (In), Ge, P, As, Sb, Bi, S, selenium (Se), tellurium (Te), Pd, and mixtures thereof.

Non-limiting examples of the transition metal oxides may include lithium titanium oxides, vanadium oxides, lithium vanadium oxides, etc.

Non-limiting examples of the non-transition metal oxides may include SnO₂, SiOₓ (0<x<2), etc.

Non-limiting examples of the carbonaceous materials may include crystalline carbons, amorphous carbons, and mixtures thereof. Non-limiting examples of the crystalline carbons may include graphites such as amorphous, plate-shaped, flake-shaped, spherical or fibrous natural and artificial graphites; and non-limiting examples of the amorphous carbons may include soft carbons (carbons calcined at low temperatures) or hard carbons, mesophase pitch carbides, calcined coke, etc.

The conducting agent and binder used in the positive active material composition may also be used in the negative active material composition.

The anode active material, conducting agent, binder, and solvent may be included in amounts that are suitably used in lithium batteries in the related art. One or more selected from the conducting agent, binder, and solvent may be omitted depending on the intended uses and compositions of the lithium battery.

Next, a separator that is inserted between the cathode and the anode is prepared.

The separator may be selected from any suitable separator available for lithium batteries in the related art. Separators having excellent moisture-containing capabilities while maintaining low resistance values with respect to movement of electrolyte ions may be suitably used. Examples of the separator material may include glass fiber, polyester, Teflon, polyethylene, polypropylene, polytetrafluoroethylene (PTFE), and/or mixtures thereof. The separator may be formed as a non-woven fabric or as a woven fabric. Examples of the separator may include windable separators such as polyethylene, polypropylene, etc. that are used in lithium ion batteries of the related art, and separators having excellent organic electrolytic solution-impregnating capabilities that are used in lithium ion polymer batteries of the related art. For example, the separator may be prepared according to the following method:

A separator composition may be prepared by mixing a polymer resin, a filler, and a solvent. The separator composition may be directly coated and dried on the electrodes to form a separator. Alternatively, the separator composition may be cast and dried on a support, and a separator film delaminated from the support may be laminated on the electrodes to form a separator.

The polymer resin used in the preparation of the separator is not particularly limited, and any suitable material available in the relevant art may be used as the polymer resin. Non-limiting examples of the polymer resin may include vinylidene fluoride-hexafluoropropylene copolymers, polyvinylidene fluoride (PVDF), polyacrylonitrile, polymethyl methacrylate, and mixtures thereof.

Next, an organic electrolytic solution is prepared.

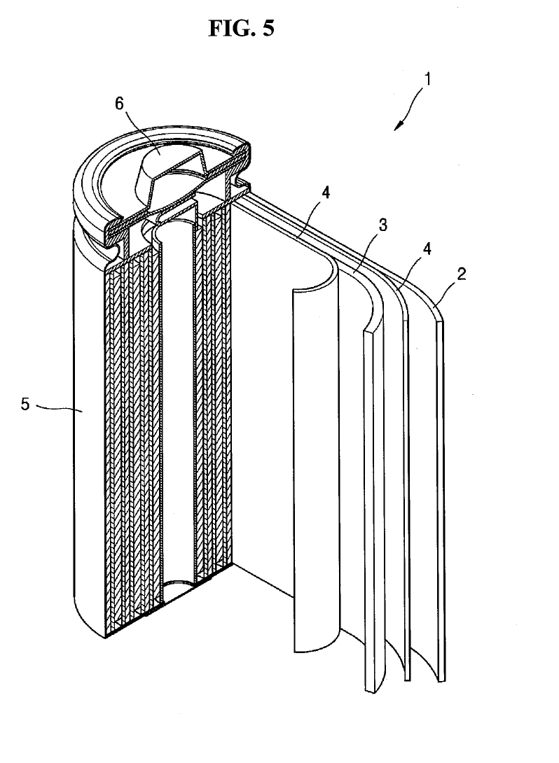

As shown in the embodiment of FIG. 5, a lithium battery 1 includes a cathode 3, an anode 2, and a separator 4. The cathode 3, the anode 2, and the separator 4 are wound or folded before they are placed inside a battery case 5. Subsequently, an organic electrolytic solution is injected into the battery case 5, and the battery case 5 containing the organic electrolytic solution is sealed by a cap assembly 6 to complete the manufacture of the lithium battery 1. Non-limiting examples of the battery case 5 may include a cylindrical battery case, a rectangular battery case, a thin film-type (e.g., thin film) battery case, etc. In some embodiments, the lithium battery 1 may be a large thin film-type (e.g., thin film) battery. The lithium battery 1 may be a lithium ion battery.

The separator 4 is between the cathode 3 and the anode 2 such that a battery structure (e.g., electrode assembly) is formed. After the battery structure is laminated on a bi-cell structure, the bi-cell structure is impregnated with an organic electrolytic solution, and the resulting impregnated structure is accommodated and sealed into a pouch to complete a lithium ion polymer battery.

Multiple battery structures may be laminated to form a battery pack, and the battery pack may be used in devices in which high capacity and high output power are required. For example, the battery pack may be used in laptop computers, smart phones, electric vehicles, etc.

The lithium battery may be used in electric vehicles (EVs), since the lithium battery has excellent lifetime characteristics and high-rate characteristics. For example, the lithium battery may be used in hybrid vehicles such as plug-in hybrid electric vehicles (PHEVs), etc. The lithium battery may be used in fields in which storage of a large amount of electric power is required. For example, the lithium battery may be used in electric bicycles, electric tools, etc.

Hereinafter, the organic electrolytic solution and the lithium battery according to example embodiments of the present disclosure will be described in more detail through the following Examples and Comparative Examples. However, such embodiments are provided for illustrative purposes only, and the scope of the present invention should not be limited thereto in any manner. Further, it should be understood that the present disclosure is not limited to the above descriptions since other various modifications of embodiments of the present disclosure may be done by one of ordinary skill in the related art of the present disclosure.

### (Preparation of Organic Electrolytic Solutions)

### EXAMPLE 1

### PSA (1 wt %)+TEP (1 wt %)

1.15 M LiPF₆ as a lithium salt, 1.0 wt % of a propylene sulfate represented by Formula 4 and 1.0 wt % of a triethyl phosphite represented by Formula 10 were added to a mixed solvent of ethylene carbonate (EC), ethyl methylcarbonate (EMC), and dimethyl carbonate (DMC) in a volume ratio of 2:4:4 to obtain an organic electrolytic solution:

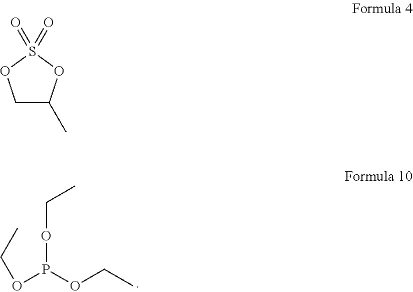

### EXAMPLE 2

### PSA (1 wt %)+TMSP (1 wt %)

1.15 M LiPF₆ as a lithium salt, 1.0 wt % of a propylene sulfate represented by Formula 4 and 1.0 wt % of a trimethylsilyl phosphite represented by Formula 12 were added to a mixed solvent of ethylene carbonate (EC), ethyl methylcarbonate (EMC), and dimethylcarbonate (DMC) in a volume ratio of 2:4:4 to obtain an organic electrolytic solution:

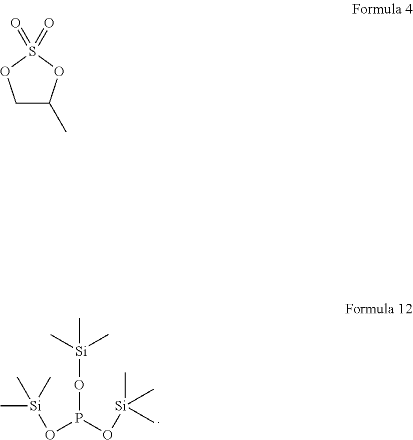

### EXAMPLE 3

### PSA (1 wt %)+DATFMP (1 wt %)

1.15 M LiPF₆ as a lithium salt, 1.0 wt % of a propylene sulfate represented by Formula 4 and 1.0 wt % of a bis(diallylamido)-2,2,2-trifluoroethyl phosphite represented by Formula 16 were added to a mixed solvent of ethylene carbonate (EC), ethyl methylcarbonate (EMC), and dimethylcarbonate (DMC) in a volume ratio of 2:4:4 to obtain an organic electrolytic solution:

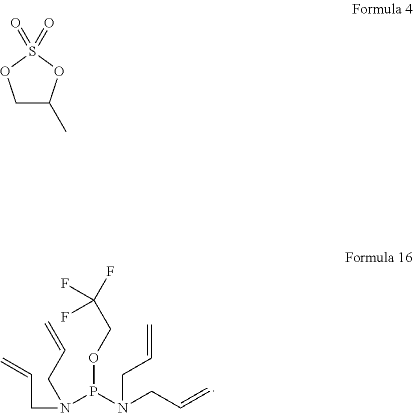

### EXAMPLE 4

### PSA (1 wt %)+TMSPA (1 wt %)

1.15 M LiPF₆ as a lithium salt, 1.0 wt % of a propylene sulfate represented by Formula 4 and 1.0 wt % of a trimethylsilyl phosphate represented by Formula 15 were added to a mixed solvent of ethylene carbonate (EC), ethyl methylcarbonate (EMC), and dimethylcarbonate (DMC) in a volume ratio of 2:4:4 to obtain an organic electrolytic solution:

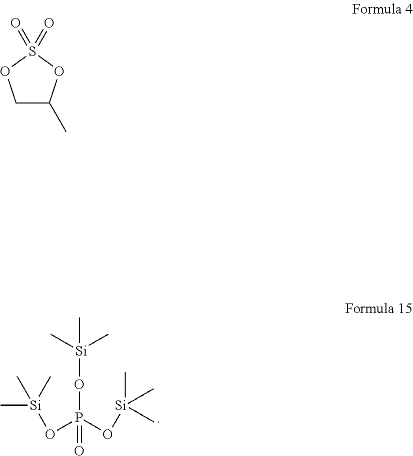

### EXAMPLE 5

### PSA (1 wt %)+CMPA (1 wt %)

1.15 M LiPF₆ as a lithium salt, 1.0 wt % of a propylene sulfate represented by Formula 4 and 1.0 wt % of a tris(2-cyanoethyl)phosphate represented by Formula 14 were added to a mixed solvent of ethylene carbonate (EC), ethyl methylcarbonate (EMC), and dimethylcarbonate (DMC) in a volume ratio of 2:4:4 to obtain an organic electrolytic solution:

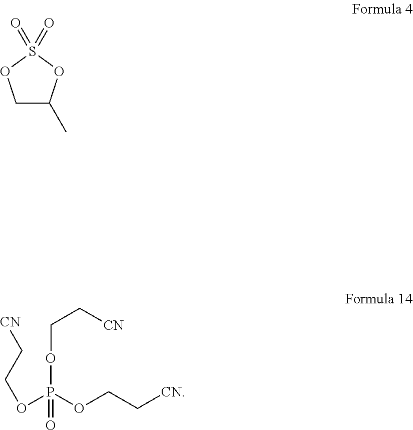

### COMPARATIVE EXAMPLE 1

### No Additives

1.15 M LiPF₆ as a lithium salt was added to a mixed solvent of ethylene carbonate (EC), ethyl methylcarbonate (EMC), and dimethylcarbonate (DMC) at a volume ratio of 2:4:4 to prepare an organic electrolyte solution.

### COMPARATIVE EXAMPLE 2

### PSA (1 wt %) Only

1.15 M LiPF₆ as a lithium salt and 1.0 wt % of a propylene sulfate represented by Formula 4 were added to a mixed solvent of ethylene carbonate (EC), ethyl methylcarbonate (EMC), and dimethylcarbonate (DMC) in a volume ratio of 2:4:4 to obtain an organic electrolytic solution:

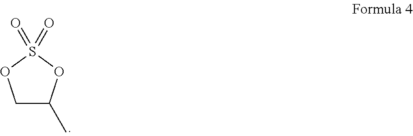

### COMPARATICE EXAMPLE 3

### ESA (1 wt %) Only

1.15 M LiPF₆ as a lithium salt and 1.0 wt % of an ethylene sulfate represented by Formula 18 were added to a mixed solvent of ethylene carbonate (EC), ethyl methylcarbonate (EMC), and dimethylcarbonate (DMC) in a volume ratio of 2:4:4 to obtain an organic electrolytic solution:

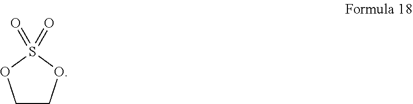

### (Manufacturing of Lithium Batteries)

### EXAMPLE 6

### Manufacturing an Anode

After mixing about 97% by weight of MC20 graphite particles (produced by Mitsubishi Chemical Corporation), about 1.5% by weight of BM408 as a conducting agent (produced by Daicel Corporation), and about 1.5% by weight of BM400-B as a binder (produced by Zeon Corporation), the mixture was poured into distilled water, and the mixture and distilled water were stirred using a mechanical stirrer for about 60 minutes to prepare a negative active material slurry. The negative active material slurry was coated on a 10 μm-thick copper (Cu) current collector to a thickness of about 60 μm with a doctor blade. The resultant film was dried in a hot-air dryer at about 100° C. for about 0.5 hour, and then at about 120° C. in a vacuum for 4 hours, followed by roll-pressing to manufacture an anode having the anode active material layer on the current collector. The anode had a density (ED, e.g., electrode density of the electrode material mixture) of about 1.55 g/cc and a loading level (LL) of about 14.26 mg/cm².

### (Manufacturing of a Cathode)

After mixing about 94% by weight of NCM 65 as Zr-coated LiNi_{0.65}Co_{0.20}Mn_{0.15}O₂ (produced by Samsung SDI Co., Ltd.), about 3.0% by weight of Denka black as a conducting agent (produced by Denka Co., Ltd), and about 3.0% by weight of PVDF Solef 6020 as a binder (produced by Solvay Corporation) and adding the mixture to N-methyl-2-pyrrolidone solvent, the mixture and the N-methyl-2-pyrrolidone solvent were stirred using a mechanical stirrer for about 30 minutes to prepare a positive active material slurry. The positive active material slurry was coated on a 20 μm-thick aluminum (Al) current collector to a thickness of about 60 μm with a doctor blade. The resultant film was dried in a hot-air dryer at about 100° C. for about 0.5 hour, and then at about 120° C. in a vacuum for 4 hours, followed by roll-pressing to manufacture a cathode having the cathode active material layer on the current collector. The cathode had a density (ED, e.g., electrode density of the electrode material mixture) of about 3.15 g/cc and a loading level (LL) of about 27.05 mg/cm².

### (Assembling of a Battery)

A pouch-type (e.g., pouch format) lithium battery was manufactured using a ceramic-coated polyethylene separator having a thickness of about 16 microns (produced by SK Innovation Co., Ltd.), and the organic electrolytic solution prepared in Example 1.

### EXAMPLES 7 to 10

Lithium batteries were manufactured using substantially the same method as in Example 6, except that the organic electrolytic solutions prepared in Examples 2 to 5 were respectively used instead of the organic electrolytic solution prepared in Example 1.

### COMPARATIVE EXAMPLES 4 to 6

Lithium batteries were manufactured using substantially the same method as in Example 6, except that the organic electrolytic solutions prepared in Comparative Examples 1 to 3 were respectively used instead of the organic electrolytic solution prepared in Example 1.

### EVALUATION EXAMPLE 1

### Evaluating Charge/Discharge Characteristics at Room Temperature (25° C.)

The lithium batteries prepared according to Comparative Examples 4 to 6 were each charged at a constant current of 0.5 C at 25° C. up to a voltage of 4.2 V (vs. Li⁺/Li) followed by charging with a cut-off current 0.05 C in constant voltage mode at 4.2 V, and was then discharged at a constant current of 0.5 C down to a voltage of about 2.8 V (vs. Li⁺/Li) (formation process, 1^{st} cycle).

After the 1^{st} formation cycle, each lithium battery was charged at a constant current of 0.5 C at about 25° C. to a voltage of about 4.2 V (vs. Li⁺/Li), followed by charging with a cut-off current of 0.05 C in constant voltage mode at 4.2 V, and was then discharged at a constant current of 1.5 C down to a voltage of about 2.8 V (vs. Li⁺/Li). The cycle of charging and discharging was repeated 300 times.

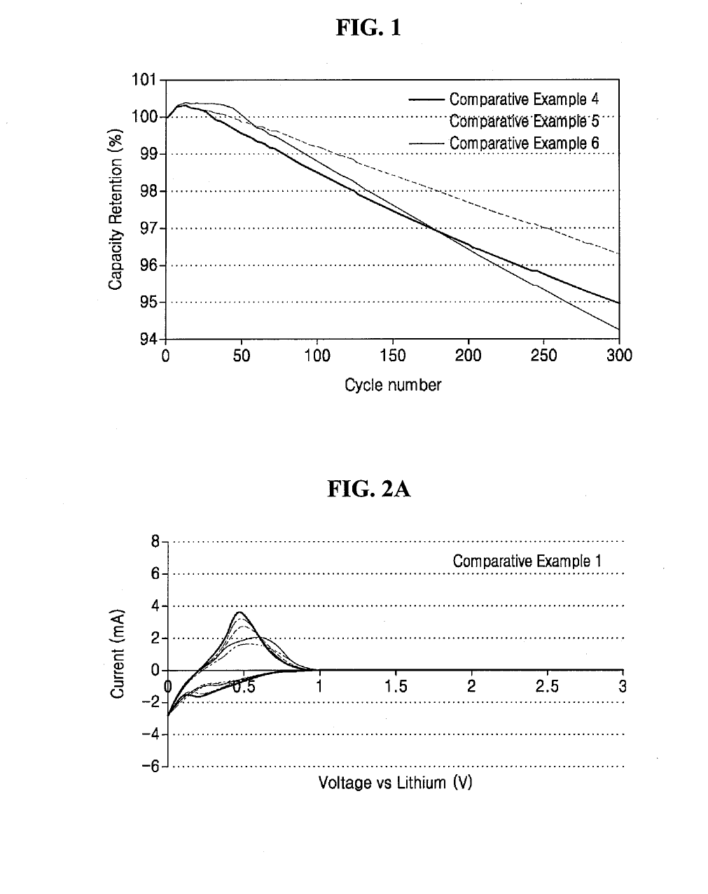

Selected charge/discharge test results are shown in Table 1 and FIG. 1. The capacity retention rates at the 300^{th} cycle are defined as in the following Equation 1:

Capacity retention rate=[discharge capacity at the 300^{th} cycle/discharge capacity at the first cycle]×100 Equation 1

Selected capacity retention rates measured at room temperature are shown in the following Table 1:

TABLE 1

| | Capacity retention rates [%] at |
|---|---|
| | room temperature (25° C.) |
| Comparative | 94.9 |
| Example 4 | |
| Comparative | 96.3 |
| Example 5 | |
| Comparative | 94.3 |
| Example 6 | |

As shown in Table 1 and FIG. 1, the lithium battery of Comparative Example including propylene sulfate showed improved room temperature lifetime characteristics, compared to the lithium battery of Comparative Example 6 including ethylene sulfate.

### EVALUATION EXAMPLE 2

### Evaluation of Cyclic Voltammetry (CV) Characteristics

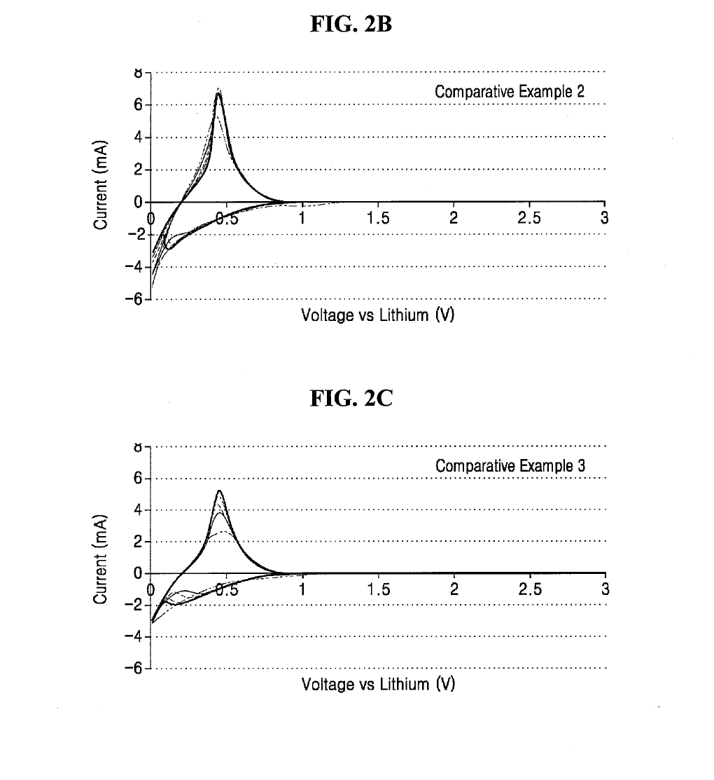

The dependence of current on changes in voltage were measured with cyclic voltammetry while scanning five times at a speed of about 1 mV/sec in a voltage range of about 0 V to about 3 V (vs. Li⁺/Li metal) using the anode used in the manufacture of the lithium battery of Comparative Example 4 as a working electrode with respect to the organic electrolytic solutions prepared in Comparative Examples 1 to 3. The measurement results are shown in FIGS. 2A-2D.

In the cyclic voltammetry measuring process, the anode of the lithium battery of Comparative Example 4 was used as a working electrode, Li metal was used as a counter electrode and a reference electrode, and the organic electrolytic solutions prepared in Comparative Examples 1 to 3 were each used as the electrolytic solution.

It was confirmed, as shown in FIGS. 2A-2C, that Comparative Example 2 (propylene sulfate alone) and Comparative Example 3 (ethylene sulfate alone) showed higher current peaks on oxidation than Comparative Example 1 (containing no additives), corresponding to formation of solid electrolyte films on the anode surfaces. As shown in FIG. 2B, a durable coating film (solid electrolyte interphase film) was formed during the first cycle in Comparative Example 2 since there was no change (e.g., increase) in the amount of current from the second cycle on in Comparative Example 2.

As shown in FIG. 2D, a strong solid electrolyte interphase film having a composition that was different from those of Comparative Examples 1 and 3 was formed on the anode surface in Comparative Example 2 since a reduction peak in the vicinity of 1 V was observed in the first cycle in Comparative Example 2.

### EVALUATION EXAMPLE 3

### Evaluating Charge/Discharge Characteristics at Room Temperature (25° C.)

The lithium batteries prepared according to Examples 6 to 10 and Comparative Examples 4 to 5 were each charged at a constant current of 0.5 C at 25° C. up to a voltage of 4.2 V (vs. Li⁺/Li), followed by charging with a cut-off current of 0.05 C in constant voltage mode at 4.2 V, and was then discharged at a constant current of 0.5 C down to a voltage of about 2.8 V (vs. Li⁺/Li) (formation process, 1^{st} cycle)

After the 1^{st} formation cycle, each lithium battery was charged at a constant current of 0.5 C at about 25° C. to a voltage of about 4.2 V (vs. Li⁺/Li), followed by charging with a cut-off current of 0.05 C in constant voltage mode at 4.2 V, and was then discharged at a constant current of 1.5 C down to a voltage of about 2.8 V (vs. Li⁺/Li). The cycle of charging and discharging was repeated 150 times.

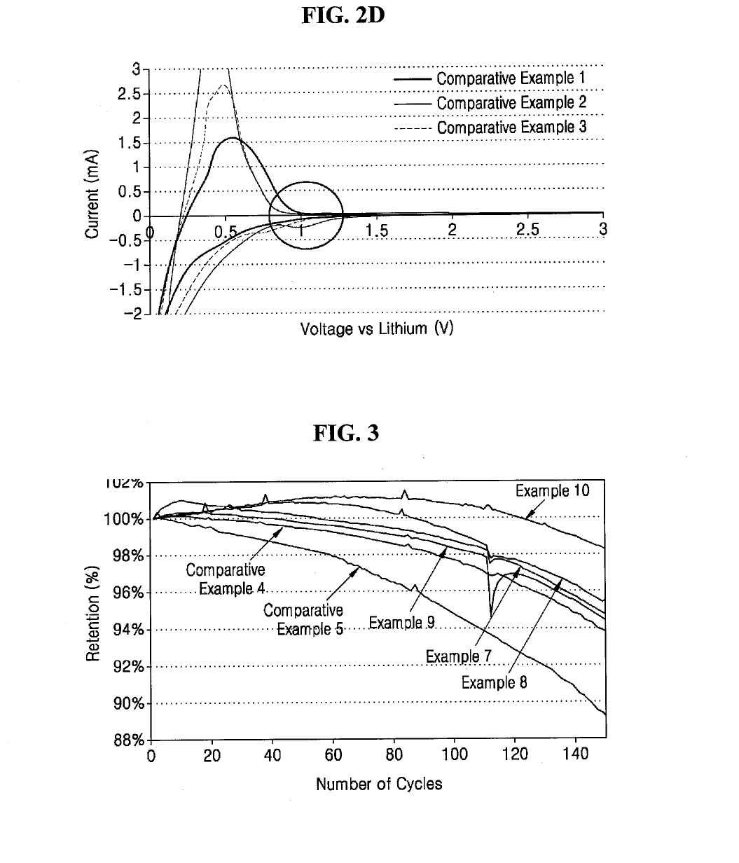

Selected charge/discharge test results are shown in the following Table 2 and FIG. 3. Capacity retention rates at the 150^{th} cycle are defined as the following Equation 2.

Capacity retention rate=[discharge capacity at the 150^{th} cycle/discharge capacity at the first cycle]×100 Equation 2

Selected capacity retention rates measured at room temperature are shown in the following Table 2:

TABLE 2

| | Capacity retention rates [%] at |
|---|---|
| | room temperature (25° C.) |
| Example 7 | 94.7 |
| Example 8 | 95.5 |
| Example 9 | 94.4 |
| Example 10 | 98.2 |
| Comparative | 89.2 |
| Example 4 | |
| Comparative | 93.8 |
| Example 5 | |

As shown in Table 2 and FIG. 3, the lithium batteries of Examples 7 to 10 including an organic electrolytic solution of embodiments of the present disclosure showed improved room temperature lifetime characteristics, compared to the lithium batteries of Comparative Examples 4 to 5 that do not include the organic electrolytic solution of embodiments of the present disclosure.

### EVALUATION EXAMPLE 4

### Evaluation of High Temperature Storage Characteristics

High temperature storage characteristics were measured by the following method:

The lithium batteries prepared according to Examples 6 to 10 and Comparative Examples 4 to 5 were each charged at a constant current of 0.5 C at 25° C. up to a voltage of 4.2 V (vs. Li⁺/Li), followed by charging with a cut-off current of 0.05 C in constant voltage mode at 4.2 V, and was then discharged at a constant current of 0.5 C until the voltage reached about 2.8 V (vs. Li⁺/Li) (formation process, 1^{st} cycle)

After the 1^{st} formation cycle, each lithium battery was charged at a constant current of 0.5 C at about 25° C. to a voltage of about 4.2 V (vs. Li⁺/Li), followed by charging with a cut-off current of 0.05 C in constant voltage mode at 4.2 V. The charged batteries were stored in a 60° C. oven for about 5 days and about 10 days, respectively, and then cooled to a room temperature of about 25° C. The battery voltages were measured with respect to the cooled lithium batteries.

Voltage retention rates were calculated from the initial voltage of about 4.2 V, the battery voltages were measured after about 5 days storage, and the battery voltages were measured after about 10 days storage. The voltage retention rates are defined by the following Equation 3:

Voltage retention rate=[battery voltage measured after high temperature storage/initial voltage (about 4.2 V)]×100 Equation 3

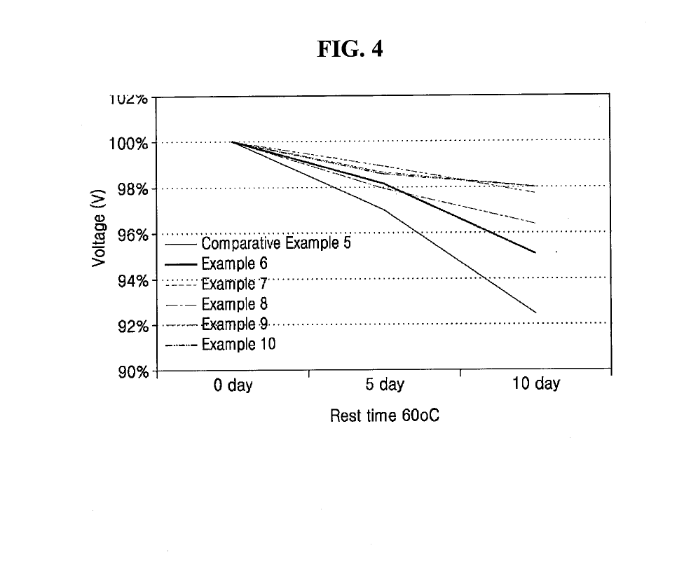

Selected measured voltage change ratios are shown in the following Table 3 and FIG. 4:

TABLE 3

Voltage retention rates [%] after
high temperature (about 60° C.) storage

| | After a | After a |
|---|---|---|
| | five-day lapse | ten-day lapse |
| Example 6 | 97.9 | 95.1 |
| Example 7 | 98.7 | 95.1 |
| Example 8 | 97.9 | 96.4 |
| Example 9 | 98.9 | 97.7 |
| Example 10 | 98.6 | 98.0 |
| Comparative | 97.0 | 92.5 |
| Example 5 | | |

As shown in Table 3 and FIG. 4, voltage drops after exposure to a high temperature of about 60° C. were substantially decreased in the lithium batteries of Examples 6 to 10 including an organic electrolytic solution of an embodiment of the present disclosure, compared to the lithium battery of Comparative Example 5, which does not include the organic electrolytic solution of an embodiment of the present disclosure. Therefore, the high temperature storage characteristics in the lithium batteries of Examples 6 to 10 were improved compared to the lithium battery of Comparative Example 5.

As described above, according to one or more aspects of the above example embodiments, the lifetime characteristics and high temperature storage characteristics of lithium batteries may be improved by using a novel organic electrolytic solution composition.

As used herein, the terms “use”, “using”, and “used” may be considered synonymous with the terms “utilize”, “utilizing”, and “utilized”, respectively. The use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that the example embodiments described therein should be considered in a descriptive sense only and not for purposes of limitation. Descriptions of features or aspects within each example embodiment should typically be considered as available for other similar features or aspects in other example embodiments.

While one or more example embodiments have been described with reference to the drawings, it will be understood by those of ordinary skill in the art that various changes in form and details may be made therein without departing from the spirit and scope as defined by the following claims and equivalents thereof.

What is claimed is:

1. An organic electrolytic solution comprising:
an organic solvent,
a lithium salt,
one or more ester sulfate compounds represented by the following Formula 1, and
one or more phosphoric acid-based ester compounds represented by one or more of the following Formulas 2 and 3: 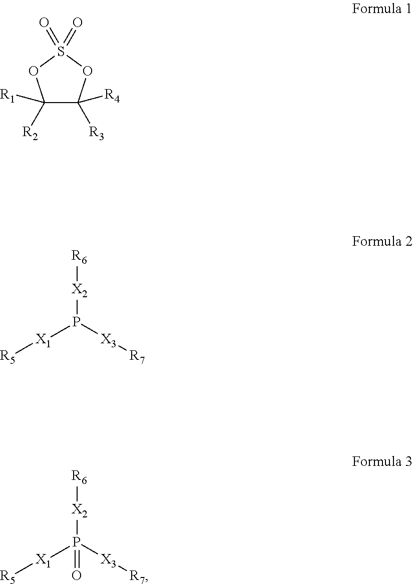
wherein R₁, R₂, R₃, and R₄ are each independently selected from hydrogen and an unsubstituted or halogen-substituted C₁-C₅ alkyl group, and at least one selected from R₁, R₂, R₃, and R₄ is an alkyl group; X₁, X₂, and X₃ are each independently selected from O, S, and NR₈; R₅, R₆, R₇, and R₈ are each independently selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ are each independently selected from an unsubstituted or halogen-substituted C₁-C₅ alkyl group.

2. The organic electrolytic solution of claim 1, wherein the ester sulfate compounds are represented by one or more of the following Formulas 4 to 6:

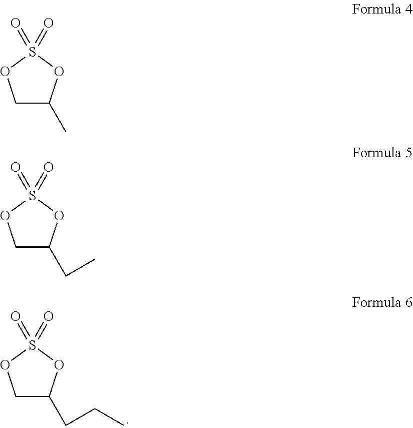

3. The organic electrolytic solution of claim 1, wherein the phosphoric acid-based ester compounds are represented by one or more of the following Formulas 7 and 8: 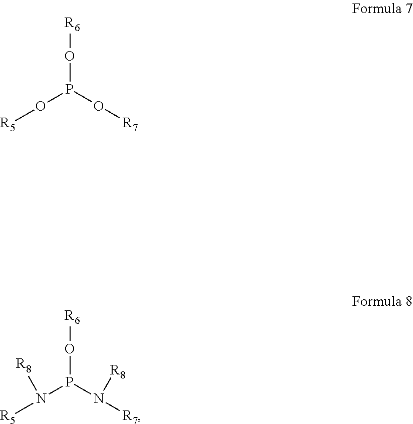
wherein R₅, R₆, R₇, and R₈ are each independently selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ are each independently selected from an unsubstituted or halogen-substituted C₁-C₅ alkyl group.

4. The organic electrolytic solution of claim 1, wherein the phosphoric acid-based ester compounds are represented by the following Formula 9: 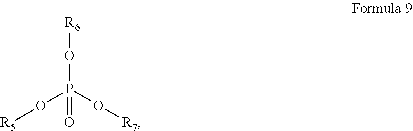
wherein R₅, R₆, R₇, and R₈ are each independently selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ are each independently selected from an unsubstituted or halogen-substituted C₁-C₅ alkyl group.

5. The organic electrolytic solution of claim 1, wherein the phosphoric acid-based ester compounds are represented by one or more of the following Formulas 10 to 17:

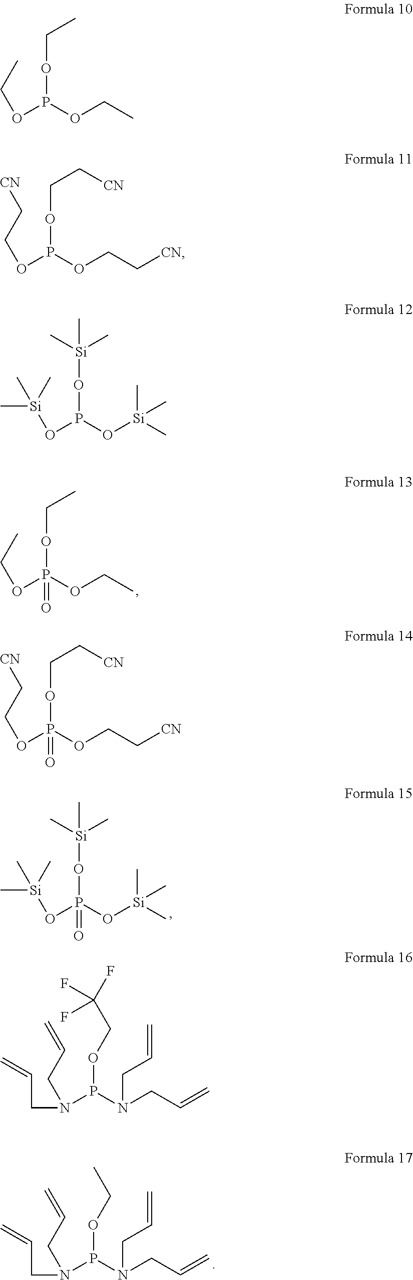

6. The organic electrolytic solution of claim 1, wherein the ester sulfate compounds are included in an amount of about 0.1 wt % to about 10 wt % based on the total weight of the organic electrolytic solution.

7. The organic electrolytic solution of claim 1, wherein the phosphoric acid-based ester compounds are included in an amount of about 0.1 wt % to about 10 wt % based on the total weight of the organic electrolytic solution.

8. The organic electrolytic solution of claim 1, wherein the organic solvent comprises one or more selected from dialkyl carbonates, cyclic carbonates, linear and cyclic esters, linear and cyclic amides, aliphatic nitriles, linear and cyclic ethers, and derivatives thereof.

9. The organic electrolytic solution of claim 1, wherein the organic solvent comprises one or more selected from dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), butylene carbonate, ethyl propionate, ethyl butyrate, acetonitrile, succinonitrile (SN), dimethyl sulfoxide, dimethyl formamide, dimethyl acetamide, γ-valerolactone, γ-butyrolactone, and tetrahydrofuran.

10. The organic electrolytic solution of claim 1, wherein the lithium salt comprises one or more selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each an integer selected from 1 to 20), LICl, and LiI.

11. The organic electrolytic solution of claim 1, wherein the lithium salt is included in a concentration of about 0.01 M to about 2.0 M in the organic electrolytic solution.

12. A lithium battery comprising:
a cathode;
an anode; and
the organic electrolytic solution of claim 1.

13. The lithium battery of claim 12, wherein the ester sulfate compounds are represented by one or more of the following Formulas 4 to 6:

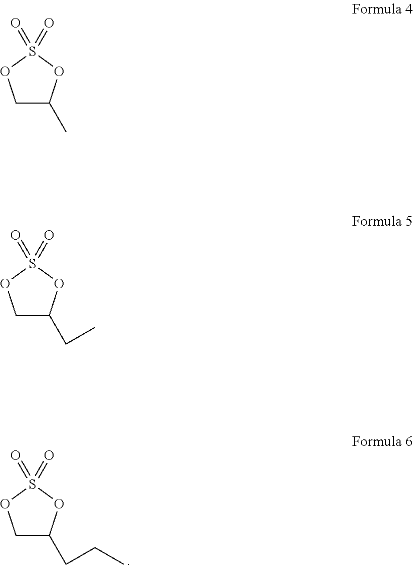

14. The lithium battery of claim 12, wherein the phosphoric acid-based ester compounds are represented by one or more of the following Formulas 7 and 8: 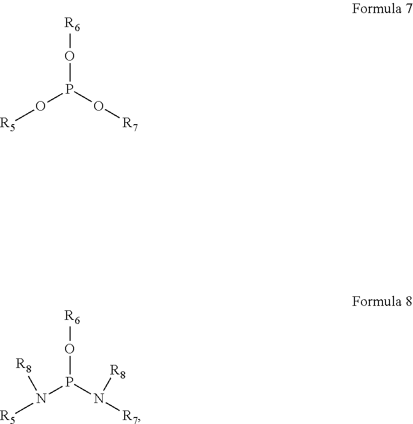
wherein R₅, R₆, R₇, and R₈ are each independently selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ are each independently selected from an unsubstituted or halogen-substituted C₁-C₅ alkyl group.

15. The lithium battery of claim 12, wherein the phosphoric acid-based ester compounds are represented by the following Formula 9: 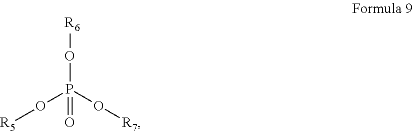
wherein R₅, R₆, R₇, and R₈ are each independently selected from an unsubstituted or halogen-substituted C₁-C₅ alkyl group, an unsubstituted or halogen-substituted C₁-C₅ cyanoalkyl group, an unsubstituted or halogen-substituted C₁-C₅ alkenyl group, and —Si(R₉)(R₁₀)(R₁₁); and R₉, R₁₀, and R₁₁ are each independently selected from an unsubstituted or halogen-substituted C₁-C₅ alkyl group.

16. The lithium battery of claim 12, wherein the phosphoric acid-based ester compounds are represented by one or more of the following Formulas 10 to 17:

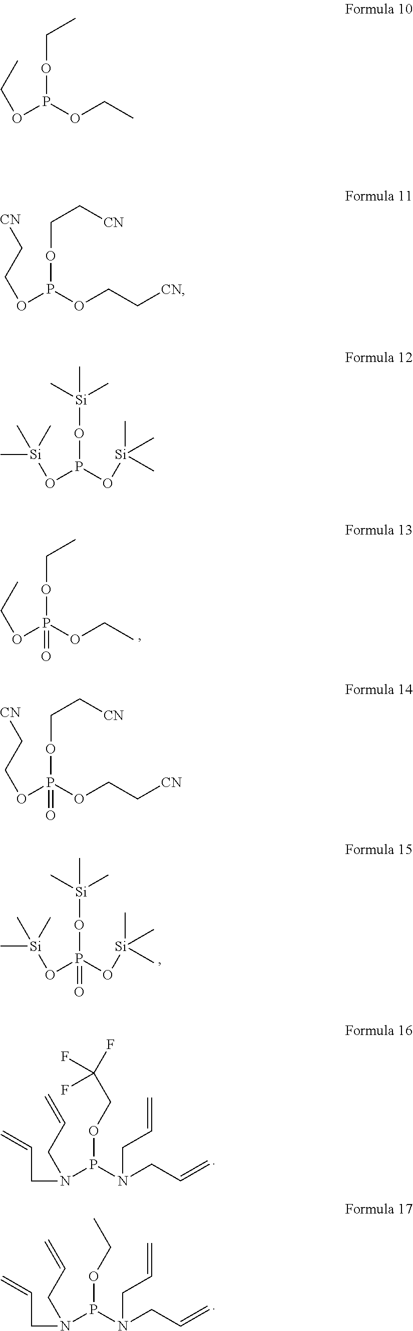

17. The lithium battery of claim 12, wherein the ester sulfate compounds are included in an amount of about 0.1 wt % to about 10 wt % based on the total weight of the organic electrolytic solution.

18. The lithium battery of claim 12, wherein the phosphoric acid-based ester compounds are included in an amount of about 0.1 wt % to about 10 wt % based on the total weight of the organic electrolytic solution.

19. The lithium battery of claim 12, wherein the organic solvent comprises one or more selected from dialkyl carbonates, cyclic carbonates, linear and cyclic esters, linear and cyclic amides, aliphatic nitriles, linear and cyclic ethers, and derivatives thereof.

20. The lithium battery of claim 12, wherein the lithium salt comprises one or more selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each an integer selected from 1 to 20), LiCl, and LiI.
